(19) United States
(12) Patent Application Publication
(10) Pub. No.: US 2010/0255389 A1
(43) Pub. Date: Oct. 7, 2010

(54) FUEL CELL

(76) Inventors: Akira Yajima, Tokyo (JP); Asako Satoh, Yokohama-shi (JP); Hirofumi Kan, Kawasaki-shi (JP); Risa Aoki, Yokohama-shi (JP); Yuichi Yoshida, Tsukuba-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/816,515

(22) Filed: Jun. 16, 2010

Related U.S. Application Data
(63) Continuation of application No. PCT/JP2008/072275, filed on Dec. 8, 2008.

(30) Foreign Application Priority Data
Dec. 17, 2007 (JP) 2007-325139
Oct. 9, 2008 (JP) 2008-263061

(51) Int. Cl. H01M 8/06

(52) U.S. Cl. 429/413

(57) ABSTRACT

A fuel cell includes a membrane electrode assembly includes a fuel electrode, an air electrode and an electrolyte membrane interposed between the fuel electrode and the air electrode, a fuel supply mechanism disposed on the air electrode side of the membrane electrode assembly to supply fuel to the fuel electrode, and a humidification layer disposed on the air electrode side of the membrane electrode assembly to be impregnated with water produced in the air electrode. The humidification layer include a first humidification section disposed opposite to a high-temperature area of an air electrode and a second humidification section disposed opposite to a low-temperature area of the air electrode when generating electricity. The second humidification section is so configured that water vapor is released into air therefrom more easily than from the first humidification section in the membrane electrode assembly.

### CROSS REFERENCE TO RELATED APPLICATIONS

This is a Continuation Application of PCT Application No. PCT/JP2008/072275, filed Dec. 8, 2008, which was published under PCT Article 21(2) in Japanese.

This application is based upon and claims the benefit of priority from prior Japanese Patent Applications No. 2007-325139, filed Dec. 17, 2007; and No. 2008-263061, filed Oct. 9, 2008, the entire contents of both of which are incorporated herein by reference.

### BACKGROUND OF THE INVENTION

1. Field of the Invention

The present invention relates to a fuel cell, and particularly to a fuel cell using liquid fuel.

2. Description of the Related Art

Recently, there have been attempts to use fuel cells for the power sources of various types of portable electronic devices such as notebook-type personal computers and mobile telephones, thereby making it possible to use these electronic devices without charging for a long period of time. These fuel cells have the characteristics that they can generate electricity only with supply of fuel and air and can also generate electricity continuously for a long period of time only with supply of fuel. For this reason, if these fuel cells can be small-sized, they can be very advantageous systems as the power sources of portable electronic devices.

A direct methanol fuel cell (DMFC) can be miniaturized and fuel therein is easily handled. This is why the direct methanol fuel cell is expected as the promising power source for portable electronic devices. The active system such as a gas-supply type and a liquid-supply type, and the passive type such as an internal gasification type in which liquid fuel in a fuel receiving section is vaporized inside a battery to supply the gasified fuel to a fuel electrode are known as the liquid fuel supply system in the DMFC.

Among these systems, the passive system such as an internal gasification type is particularly advantageous to miniaturize the DMFC. In the passive type DMFC, a structure is proposed in which a membrane electrode assembly (fuel battery cell) comprising a fuel electrode, an electrolyte membrane and an air electrode is disposed on the fuel receiving section constituted of a box container made of resin (see, for example, International Publication No. 2005/112172).

The fuel receiving section is connected to the fuel supply section through a passage. Liquid fuel which is supplied to the fuel supply section from the fuel receiving section through the passage is supplied to an anode gas diffusing layer of the fuel battery cell through a fuel distributing layer and an anode (fuel electrode) conductive layer either as it is or in such a state that liquid fuel is mixed with gas fuel gasified from the liquid fuel. The fuel supplied to the anode gas diffusing layer is diffused in the anode gas diffusing layer and supplied to an anode catalyst layer. When methanol fuel is used as the liquid fuel, the methanol fuel undergoes an internal reforming reaction of methanol as shown by the following formula (1) in the anode catalyst layer.

CH₃OH+H₂O→CO₂+6H⁺+6e⁻ Formula (1)

In the case of using pure methanol as the methanol fuel, methanol is reformed either by the internal reforming reaction of the above formula (1) with water generated in the cathode catalyst layer and water in the electrolyte membrane or by other reaction mechanism which needs no water.

Electrons (e⁻) produced in this reaction are conducted to the outside through the current collector, work as the so-called electricity to operate portable electronic devices, and then conducted to the cathode (air electrode). Also, protons (H⁺) produced by the internal reforming reaction of the above formula (1) are conducted to the cathode through the electrolyte membrane. Air is supplied as the oxidizer gas to the cathode through the humidification layer. The electrons (e⁻) and protons (H⁺) which reach the cathode undergo the reaction with oxygen in the air according to the following formula (2) in the cathode catalyst layer to thereby produce water along with this generating reaction.

(3/2)O₂+6e⁻+6H⁺→3H₂O Formula (2)

In order that the above internal reforming reaction is run smoothly to obtain high and stable output in a fuel cell, it is necessary to smoothly perform a cycle operation in which at least a part of the water (H₂O) produced in the cathode catalyst layer according to the formula (2) transmits the electrolyte membrane, is diffused to the anode catalyst layer and is consumed by the reaction according to the formula (1).

In order to achieve this object, a humidification layer which is impregnated with the water produced in the cathode catalyst layer to prevent the water from scattering is disposed in the vicinity of the cathode to produce the situation where the amount of water retained in the above cathode catalyst layer is larger than that retained in the above anode catalyst layer, and the water produced in the cathode catalyst layer is supplied to the anode catalyst layer through the electrolyte membrane by utilizing an osmotic phenomenon.

In such a fuel cell utilizing the humidification layer to promote the supply of water from the cathode to the anode, the humidification layer preferably has a larger thickness and a lower porosity to increase the amount of water to be supplied from the cathode to the anode. However, in this case, the fuel cell is constantly put in the situation where a large amount of water is retained in the cathode catalyst layer during generation. If the generation is continued in this situation for a long time, pores of the cathode catalyst layer are clogged with water, causing deterioration in the diffusibility of air in the cathode catalyst layer and there is therefore the case where the fuel cell is deteriorated in generating characteristics.

For this reason, the optimal values of the thickness and porosity of the humidification layer are given to supply ample water to the anode from the cathode and to prevent deterioration in the diffusibility of air in the cathode catalyst layer. The optimal values of the thickness and porosity of the humidification layer closely relate to the temperature of the cathode while the fuel cell generates electricity. When the temperature of the cathode is high, water vapor easily transmits the humidification layer and is easily transpired because water has a higher vapor pressure in the cathode catalyst layer. It is necessary to increase the thickness of the humidification layer and to reduce the porosity of the humidification layer to limit the transpiration and to supply ample water to the anode.

When the temperature of the cathode is low, on the other hand, the vapor pressure of water in the cathode catalyst layer and its vicinity is low, easily leading to the so-called flooding phenomenon in which water vapor is not much transpired externally but is condensed (liquefied) in the cathode catalyst layer to clog pores. Therefore, it is necessary to decrease the thickness of the humidification plate and to increase the porosity.

However, the temperatures at all positions of the cathode are not always even in a usual fuel cell and there is usually a temperature distribution in the direction of plane of the membrane electrode assembly. Examples of the causes of such a temperature distribution include uneven amount of the fuel to be supplied to the membrane electrode assembly from the fuel distribution layer and uneven amount of the heat to be emitted in air from the membrane electrode assembly where the heat is generated. In many of these cases, the temperature is higher in the center of the membrane electrode assembly and is lower in the periphery of the membrane electrode assembly in the direction of plane thereof.

If the humidification layer has the same thickness and porosity in the direction of plane in all parts thereof at this time, the amount of water to be supplied to the anode from the cathode is insufficient in high-temperature parts of the cathode, preventing smooth running of the above reaction of the formula (1) and causing a reduction in the output of the fuel cell. In some parts of the cathode where the temperature is lower, water in the cathode catalyst layer and its vicinity is easily condensed, which causes a reduction in output with a passage of generating time.

Also, a method is performed in which a space is formed inside the cathode or in the periphery of the cathode to thereby improve the diffusibility of air so that uniform air is supplied to the cathode. However, in this case, the temperature of the part including the space is lower than those of other parts, allowing the above phenomenon to occur significantly.

Particularly in the cathode catalyst layer and at the part corresponding to the boundary of the space in the vicinity of the catalyst layer, water vapor is easily condensed because the temperature is rapidly changed and therefore, the flooding tends to occur particularly in the periphery of the cathode catalyst layer.

### BRIEF SUMMARY OF THE INVENTION

The present invention has been made in view of the above situation and an object of the invention is to provide a fuel cell capable of maintaining the output stably for a long period of time by keeping the amount of water to be retained in the cathode constituting the membrane electrode assembly and the amount of water to be supplied from the cathode to the anode in each appropriate range in all parts extending in the direction of plane of the membrane electrode assembly.

According to a first aspect of the present invention, fuel cell comprises a membrane electrode assembly comprising a fuel electrode, an air electrode and an electrolyte membrane interposed between the fuel electrode and the air electrode; a fuel supply mechanism disposed on the air electrode side of the membrane electrode assembly to supply fuel to the fuel electrode; and a humidification layer disposed on the air electrode side of the membrane electrode assembly to be impregnated with water produced in the air electrode, wherein the humidification layer comprises a first humidification section disposed opposite to a high-temperature area of an air electrode and a second humidification section disposed opposite to a low-temperature area of the air electrode when generating electricity, and the second humidification section is so configured that water vapor is released into air therefrom more easily than from the first humidification section in the membrane electrode assembly.

### BRIEF DESCRIPTION OF THE SEVERAL VIEWS OF THE DRAWING

FIG. 1 is a view schematically showing an example of the structure of a fuel cell according to a first embodiment of the present invention.

FIG. 2A is a view schematically showing Second Example of the structure of a humidification layer of the fuel cell shown in FIG. 1.

FIG. 2B is a view schematically showing Third Example of the structure of the humidification layer of the fuel cell shown in FIG. 1.

FIG. 3 is a view schematically showing an example of the structure of a fuel cell according to a third embodiment of the present invention.

FIG. 4 is a view for explaining an example of the results of evaluation for fuel cells according to First to Third Examples and First and Second Comparative Examples of the present invention.

FIG. 5 is a view for explaining a modification of the fuel cell according to the first embodiment of the present invention.

FIG. 6 is a view for explaining an example of the structure of a humidification layer of the fuel cell shown in FIG. 5.

FIG. 7 is a view for explaining a modification of the fuel cell according to the second embodiment of the present invention.

FIG. 8 is a view for explaining a modification of the fuel cell according to the third embodiment of the present invention.

FIG. 9 is a view for explaining an example of the structure of a humidification layer of the fuel cell shown in FIG. 8.

FIG. 10 is a view for explaining another example of the structure of the humidification layer of the fuel cell shown in FIG. 8.

FIG. 11 is a view for explaining an example of the results of evaluation for fuel cells according to Fourth and Fifth Examples and Third and Fourth Comparative Examples of the present invention.

### DETAILED DESCRIPTION OF THE INVENTION

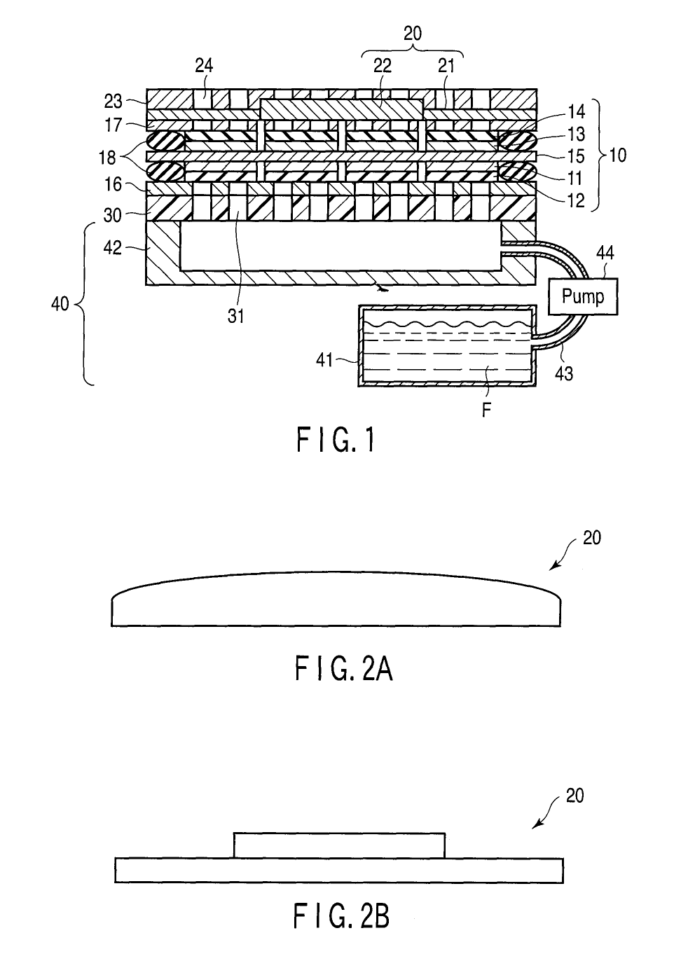

A fuel cell according to an embodiment of the present invention will be explained with reference to the drawings. As shown in FIG. 1, the fuel cell according to this embodiment comprises a membrane electrode assembly 10. The membrane electrode assembly 10 comprises an anode, a cathode and an electrolyte membrane 15 interposed between the anode (fuel electrode) and the cathode (air electrode).

The anode comprises an anode gas diffusion layer 12 and an anode catalyst layer 11 disposed on the anode gas diffusion layer 12. The cathode comprises a cathode gas diffusion layer 14 and a cathode catalyst layer 13 disposed on the cathode gas diffusion layer 14.

In the fuel cell according to this embodiment, the anode is produced, for example, in the following production method. First, a perfluorocarbonsulfonic acid solution used as a protonic conductive resin, and water and methoxypropanol used as dispersants are added to carbon black carrying anode catalyst particles (Pt:Ru=1:1) and this carbon black carrying anode catalyst particles are dispersed in the dispersants to prepare a paste. The obtained paste is applied to porous carbon paper (for example, a rectangular form of 80 mm×10 mm) used as the anode gas diffusion layer 12, thereby making it possible to obtain the anode catalyst layer 11 having a thickness of, for example, 100 μm.

In the fuel cell according to this embodiment, the cathode is produced, for example, in the following production method. First, a perfluorocarbonsulfonic acid solution used as a protonic conductive resin, and water and methoxypropanol used as dispersants are added to carbon black carrying cathode catalyst particles (Pt) and this carbon black carrying cathode catalyst particles are dispersed in the dispersants to prepare a paste. The obtained paste is applied to porous carbon paper (for example, a rectangular form of 80 mm×10 mm) used as the cathode gas diffusion layer 14, thereby making it possible to obtain the cathode catalyst layer 13 having a thickness of, for example, 100 μm.

It is to be noted that in the fuel cell according to this embodiment, the anode gas diffusion layer 12 and the cathode gas diffusion layer 14 have almost the same shape and size, and also, the anode catalyst layer 11 and cathode catalyst layer 13 applied to these gas diffusion layers, respectively, also have almost the same shape and size.

As mentioned above, the perfluorocarbonsulfonic acid film (trade name: Nafion film, manufactured by Du Pont) having a thickness of 30 μm and a moisture content of 10 to 20% by weight is disposed as the electrolyte membrane 15 between the anode catalyst layer 11 and cathode catalyst layer 13 manufactured in the above manner and is then subjected to hot pressing under the condition that the anode catalyst layer 11 is disposed opposite to the cathode catalyst layer 13, thereby making it possible to obtain the membrane electrode assembly 10. In the fuel cell according to this embodiment, four anodes and four cathodes are arranged such that their longitudinal sides are almost parallel to each other.

Next, an anode conductive layer 16 and a cathode conductive layer 17 each comprising plural openings are formed opposite the anode catalyst layer 11 on the surface of the anode gas diffusion layer 12 and opposite the cathode catalyst layer 13 on the surface of the cathode gas diffusion layer 14, respectively, in this membrane electrode assembly 10. A porous layer (for example, a mesh) or a foil made of a metal material such as gold and nickel, or a composite material obtained by coating a conductive metal material such as stainless steel (SUS) with a conductive metal such as gold may be used for these anode conductive layer 16 and cathode conductive layer 17. A rubber O-ring 18 is set between the electrolyte membrane 15 and the anode conductive layer 16 and between the electrolyte membrane 15 and the cathode conductive layer 17 to seal the membrane electrode assembly 10. The anode conductive layer 16 and the cathode conductive layer 17 are wired on the outside of the membrane electrode assembly 10 such that the above four pairs of anodes and cathodes are electrically connected in series.

A humidification layer 20 is laminated on the cathode conductive layer 17. The humidification layer 20 of the fuel cell according to this embodiment comprises a first humidification section 22 disposed opposite to a high-temperature area of the air electrode and a second humidification section 21 disposed opposite to a low-temperature area of the air electrode when generating electricity. The first humidification section 22 is formed to be thicker than the second humidification section 21.

The humidification layer 20 comprises, as shown in, for example, FIG. 1, the first humidification section 22 disposed opposite to the center in the direction of plane of the air electrode and the second humidification section 21 disposed opposite to the periphery in the direction of plane of the air electrode. In the case shown in FIG. 1, the second humidification section 21 has a through-hole penetrated in the direction of thickness in the center in the direction of plane. The first humidification section 22 is fitted into a substantially rectangular hole formed in the second humidification section. Here, the first and second humidification sections 21 and 22 are secured without using any particular adhesive or the like and are supported by utilizing the elasticity of the polyethylene porous film itself.

Examples of the method used to form the humidification layer 20 include, besides the above methods, a method in which the surface of the periphery in the direction of plane of the humidification layer 20 is abraded to make the second humidification section 21 thinner than the first humidification section 22, and a method in which, as shown in FIG. 2B, the humidification layer 20 is formed from plural layers, wherein the first humidification section 22 is formed from more layers than the second humidification section 21 to thereby make the second humidification section 21 thinner than the first humidification section 22.

In the case of using, for example, the method in which the surface of a thick polyethylene porous film is abraded, the humidification layer 20 may be formed in such a manner that either the thickness is not continuous between the second humidification section 21 and the first humidification section 22 (periphery and center in the direction of plane) as shown in FIG. 1, or the thickness is continuously varied between the second humidification section 21 and the first humidification section 22 (from the periphery to the center in the direction of plane) as shown in FIG. 2A.

Also, as shown in FIG. 2B, plural humidification layers are laminated to make the humidification layer 20 have a higher thickness in the center than in the periphery thereof. Examples of the method which may be used include a method in which the surface of the periphery in the direction of plane of a 1.0-mm-thick polyethylene porous film is abraded to a depth of 0.25 mm to decrease the thickness of the film to 0.75 mm and a method in which a 0.25-mm-thick polyethylene porous film is laminated only on the center in the direction of plane of the polyethylene porous film having a thickness of 0.75 mm.

In this case, if a space is formed between the cathode conductive layer 17 and the humidification layer 20, there is a fear that water vapor is condensed in the space leading to production of liquid water, which clogs pores of the cathode gas diffusion layer 14 and cathode catalyst layer 13 to cause flooding. Therefore, the cathode conductive layer 17 is desirably in as close contact with the humidification layer 20 as possible. This is the reason why when the humidification layer 21 in the periphery in the plane direction is fitted to the humidification layer 22 in the center in the plane direction in the above method of producing the humidification layer 20, the sides which are to be in contact with the cathode conductive layer 17 are disposed on the same plane.

A cover plate 23 is disposed on this humidification layer 20. In the fuel cell according to this embodiment, the cover plate 23 is manufactured by forming, for example, 120 air introduction ports 24 having a square form of 3 mm×3 mm in a 1-mm-thick stainless plate (SUS304) and engraving a part corresponding to the humidification layer 22 on the center in the plane direction to a depth of 0.25 mm to reduce the thickness to 0.75 mm.

Examples of the method of forming the cover plate 23 may include, besides the above methods, a method in which a plate having a uniform thickness is molded so as to form a convex shape from the periphery toward the center in the plane direction by pressing or the like, and a method in which a 0.25-mm-thick stainless plate is laminated only on the periphery of a 0.75-mm-thick stainless plate in the direction of plane thereof.

On the other hand, a fuel supply mechanism 40 that supplies a liquid fuel F to a fuel distribution layer 30 mainly comprises a fuel receiving section 41, a fuel supply section 42 and a passage 43 as shown in FIG. 1.

A liquid fuel F corresponding to the fuel battery cell is received in the fuel receiving section 41. Examples of the liquid fuel F include methanol fuels such as aqueous methanol solutions having different concentrations and pure methanol. The liquid fuel F is not limited to these methanol fuels. The liquid fuel F may be, for example, ethanol fuels such as an aqueous ethanol solution and pure ethanol, propanol fuels such as an aqueous propanol solution and pure propanol, glycol fuels such as an aqueous glycol solution and pure glycol, dimethyl ether, formic acid and other liquid fuels. In any case, liquid fuel according to a fuel battery cell is received in the fuel receiving section 41.

The fuel supply section 42 is connected to the fuel receiving section 41 through the passage 43 for the liquid fuel F constituted of a pipe or the like. The liquid fuel F is introduced into the fuel supply section 42 through the passage 43 from the fuel receiving section 41. The introduced liquid fuel F and/or a gasified component produced by the vaporization of the liquid fuel F are supplied to the membrane electrode assembly 10 through the fuel distribution layer 30 and anode conductive layer 16. The passage 43 is not limited to a pipe independent of the fuel supply section 42 and fuel receiving section 41. When, for example, the fuel supply section 42 and the fuel receiving section 41 are laminated to integrate the both, the passage 43 may be a passage connecting the both for the liquid fuel F. Specifically, the fuel supply section 42 is only required to be communicated with the fuel receiving section 41 through the passage 43 and the like.

The liquid fuel F received in the fuel receiving section 41 can be fed to the fuel supply section 42 by allowing the fuel to fall through the passage 43 by utilizing gravitation. Also, a porous body may be filled in the passage 43 to feed the liquid fuel F received in the fuel receiving section 41 to the fuel supply section 42 by the capillary phenomenon. Moreover, a pump may be provided in a part of the passage 43 to forcibly feed the liquid fuel F received in the fuel receiving section 41 to the fuel supply section 42.

The fuel distribution layer 30 is constituted of, for example, a plane plate formed with plural openings 31 and sandwiched between the anode gas diffusion layer 12 and the fuel supply section 42. This fuel distribution layer 30 is constituted of a material which does not transmit a vaporized component of the liquid fuel F and the liquid fuel F, and is specifically constituted of, for example, polyethylene terephthalate (PET) resin, polyethylene naphthalate (PEN) resin or polyimide-based resin. Also, the fuel distribution layer 30 may be constituted of, for example, a gas-liquid separating film which separates a vaporized component of the liquid fuel F from the liquid fuel F to transmit the vaporized component to the membrane electrode assembly 10 side. As the gas-liquid separating film, a silicone rubber, low-density polyethylene (LDPE) thin film, polyvinyl chloride (PVC) thin film, polyethylene terephthalate (PET) thin film, fluororesin (for example, polytetrafluoroethylene (PTFE) or tetrafluoroethylene/perfluoroalkyl vinyl ether copolymer (PFA)) microporous film or the like is used.

Next, a fuel cell according to a second embodiment of the present invention will be explained. The fuel cell according to this embodiment has a structure in which the humidification layer 20 comprises a first humidification section and a second humidification section. The first humidification section is disposed opposite to a high-temperature area of the air electrode and the second humidification section is disposed opposite to a low-temperature area of the air electrode in the generation of electricity. The first humidification section is formed to have a lower porosity than the second humidification section.

In this case, the porosity of the first humidification section is desirably 30% or more and 90% or less of that of the second humidification section.

The fuel cell according to this embodiment has the same structure as the fuel cell according to the first embodiment except for the above structure.

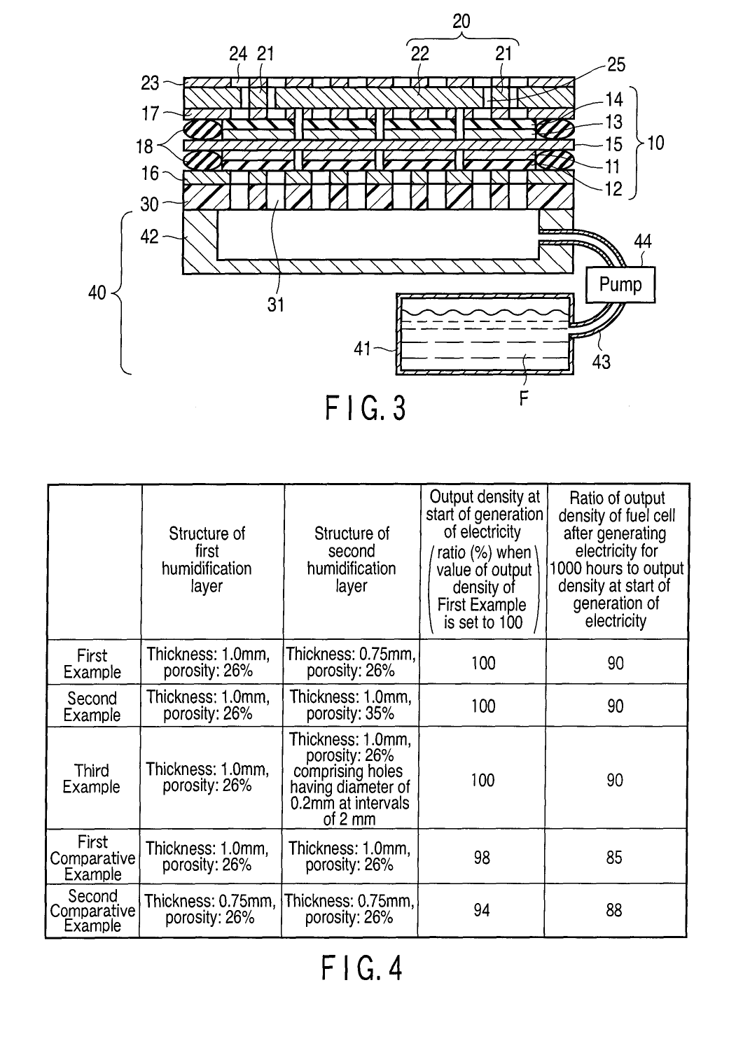

Next, a fuel cell according to a third embodiment of the present invention will be explained. The fuel cell according to this embodiment has a structure in which the humidification layer 20 comprises a first humidification section 22 and a second humidification section 21 as shown in FIG. 3. The first humidification section 22 is disposed opposite to a high-temperature area of the air electrode and the second humidification section is disposed opposite to a low-temperature area of the air electrode in the generation of electricity. The second humidification section 21 has at least one of holes each having a diameter 0.1 or more times the thickness of the second humidification section 21 and slits each having a width 0.1 or more times the thickness of the second humidification section 21.

In the case shown in FIG. 3, the second humidification section 21 comprises holes which each have a given diameter and penetrate through the section in the direction of thickness (direction of Z) at predetermined intervals. Specifically, in the center of the humidification layer 20 in its plane direction, the area formed with no through-hole is the first humidification layer 22 and the surrounding pierced area is the second humidification layer 21.

The fuel cell according to this embodiment has the same structure as the fuel cell according to the first embodiment except for the above structure. Though the holes penetrate in the direction of Z in the second humidification section 21 in the case shown in FIG. 3, slits penetrating in the direction of Z may be provided in the second humidification section 21.

### EXAMPLES

Fuel cells according to examples of the present invention will be explained with reference to the drawings. It is to be noted that in the following explanations, the same structures as those of the aforementioned fuel cell are designated by the same symbols and the explanation thereof is omitted.

### First Example

An example of the fuel cell according to the first embodiment will be explained with reference to the drawings. It is to be noted that in the following explanations, the same structures as those of the aforementioned fuel cell are designated by the same symbols and the explanation thereof is omitted.

In the fuel cell according to this example, the humidification layer 20 was manufactured as follows. Specifically, a polyethylene porous film having a thickness of 0.75 mm, a porosity of 26%, an air permeability of 1.7 sec/100 cm³ (according to the measuring method prescribed in JIS P-8117) and a water-vapor permeability of 3000 g/(m²·24 h) (according to the measuring method prescribed in JIS L-1099 A-1) was cut into a rectangular form 84 mm in length and 47 mm in width, and a rectangular hole 27 mm in length and 22 mm in width was opened in the center of the rectangular film to obtain a second humidification section 21.

Next, a polyethylene porous film having the same properties as the humidification layer 21 except for a thickness of 1.0 mm, an air permeability of 2.0 sec/100 cm³ and a water-vapor permeability of 2000 g/(m²·24 h) was cut into a rectangular form 27 mm in length and 22 mm in width as a first humidification section 22. This humidification layer 22 to be disposed in the center in the direction of plane was fitted into the rectangular hole formed in the center of the humidification layer 21 to be disposed in the periphery in the direction of plane such that these layers had the same plane on the sides which were in contact with the cathode conductive layer 17 to thereby manufacture the humidification layer 20.

Here, the humidification layer 21 in the periphery is not secured to the humidification layer 22 in the center in the direction of plane by, particularly, an adhesive or the like, but is supported by only making use of the elasticity of the polyethylene porous film itself.

Examples of the method used to manufacture the humidification layer 20 include a method in which the surface of the periphery in the direction of plane of a 1.0-mm-thick polyethylene porous film is abraded to a depth of 0.25 mm to decrease the thickness of the film to 0.75 mm and a method in which a 0.25-mm-thick polyethylene porous film is laminated only on the center of a 0.75-mm-thick polyethylene porous film in the direction of plane of the film.

In the case of using the method in which the surface of a thick polyethylene porous film is abraded as the method of manufacturing the humidification layer 20, the humidification layer 20 may be formed in such a manner that either the thickness is different between the periphery and the center in the direction of plane or the thickness is continuously varied between the periphery and the center in the direction of plane.

Pure methanol having a purity of 99.9% by weight was supplied to the fuel cell manufactured in the above manner in an environment of a temperature of 25° C. and a relative humidity of 50%. Also, a constant voltage power source was connected to the fuel cell to control current flow through the fuel cell such that the voltage output of the fuel cell was fixed to 0.3 V per one pair of four pairs of unit cells connected in series.

The output density P1 of the fuel cell after the generating operation was carried out for 1000 hours and the output density P0 of the fuel cell when the generating operation started were measured under the above condition. Then, the ratio (P1/P0) of the output density P1 to the output density P0 was calculated. Here, the output density (mW/cm³) of a fuel cell means a value obtained by multiplying the density of current flow through the fuel cell (current value (mA/cm²) per area (1 cm²) of the generating section) by output voltage of the fuel cell.

Also, the area of the generating section means an area where the anode catalyst layer 11 and the cathode catalyst layer 13 are disposed opposite to each other. Since the anode catalyst layer 11 and the cathode catalyst layer 13 have the same area and are entirely opposite to each other in this example, the area of the generating section is the same as that of the catalyst layer.

The above calculated ratio (P1/P0) of the output density P1 to the output density P0 was 0.90 (90%).

A thermocouple was inserted between the cathode gas diffusion layer 14 and the cathode conductive layer 17 at one position of each of the center and periphery of the membrane electrode assembly in the direction of plane to measure the temperature of the surface of the cathode gas diffusion layer 14 when the fuel cell generated electricity. As a result, the temperature of the surface of the cathode gas diffusion layer 14 at the center in the direction of plane was 55° C. and the temperature of the surface of the cathode gas diffusion layer 14 at the periphery in the direction of plane was 50° C.

### Second Example

Next, an example of the fuel cell according to the second embodiment will be explained with reference to the drawings. In the fuel cell according to this example, a polyethylene porous film having a thickness of 1.0 mm, a porosity of 26%, an air permeability of 2.0 sec/100 cm³ (according to the measuring method prescribed in JIS P-8117) and a water-vapor permeability of 2000 g/(m²·24 h) (according to the measuring method prescribed in JIS L-1099 A-1) was used as the first humidification section.

Also, a polyethylene porous film having a thickness of 1.0 mm, a porosity of 35%, an air permeability of 1.7 sec/100 cm³ (according to the measuring method prescribed in JIS P-8117) and a water-vapor permeability of 3000 g/(m²·24 h) (according to the measuring method prescribed in JIS L-1099 A-1) was used as the second humidification section. Also, a stainless plate having a uniform thickness of 1.0 mm was used as the surface cover 23. This fuel cell has the same structure as the fuel cell of First Example except for the above structures.

The ratio (P1/P0) of the output density P1 to output density P0 of this fuel cell of Second Example was calculated in the same manner as above, to find that it was 0.90 (90%). The ratio of the output density P0 of the fuel cell of Second Example at the start of generation to the output density P0 of the fuel cell of First Example was 100%.

The temperature of the surface of the cathode gas diffusion layer 14 when the fuel cell of this example generated electricity was measured, with the result that the temperature of the center in the direction of plane of the cathode gas diffusion layer was 55° C. and the temperature of the periphery in the direction of plane of the cathode gas diffusion layer was 50° C.

### Third Example

Next, an example of the fuel cell according to the third embodiment will be explained with reference to the drawings. In the fuel cell according to this example, a polyethylene porous film having a thickness of 1.0 mm, a porosity of 26%, an air permeability of 2.0 sec/100 cm³ and a water-vapor permeability of 2000 g/(m²·24 h) was cut into a rectangular form 84 mm in length and 47 mm in width, and circular through-holes 25 having a diameter of 0.2 mm were opened equally at intervals of 2 mm in the center part outside of a rectangular area 27 mm in length and 22 mm in width, to use the resulting film as the humidification layer 20.

Here, in the humidification layer 20, the center area where no through-hole is formed is the first humidification layer 22 and the outside area where the through-holes are formed is the second humidification layer 21. Also, as the surface cover 23, a stainless plate having a uniform thickness of 1.0 mm was used. A fuel cell was thus formed in the same manner as in First Example except for the above structures.

The ratio (P1/P0) of the output density P1 to output density P0 of this fuel cell of Third Example was calculated in the same manner as First Example, to find that it was 0.90 (90%). The ratio of the output density P0 of the fuel cell of Third Example at the start of generation to the output density P0 of the fuel cell of First Example was 100%.

The temperature of the surface of the cathode gas diffusion layer 14 when the fuel cell of this example generated electricity was measured, with the result that the temperature of the center in the direction of plane of the cathode gas diffusion layer was 55° C. and the temperature of the periphery in the direction of plane of the cathode gas diffusion layer was 50° C.

### Comparative Examples

A fuel cell according to Comparative Example of the present invention will be explained with reference to the drawings.

### First Comparative Example

A fuel cell according to First Comparative Example in the present invention will be explained. In the fuel cell according to this Comparative Example, a polyethylene porous film having a uniform thickness of 1.0 mm, a uniform porosity of 26%, an air permeability of 2.0 sec/100 cm³ (according to the measuring method prescribed in JIS P-8117) and a water-vapor permeability of 2000 g/(m²·24 h) (according to the measuring method prescribed in JIS L-1099 A-1) was cut into a rectangular form 84 mm in length and 47 mm in width, to use the resulting film as the humidification layer 20. Also, as the surface cover 23, a stainless plate having a uniform thickness of 1.0 mm was used. A fuel cell was thus formed in the same manner as in First Example except for the above structures.

The ratio (P1/P0) of the output density P1 to output density P0 of this fuel cell of this First Comparative Example was calculated in the same manner as in the case of the above First Example, to find that it was 0.85 (85%).

The ratio of the output density P0 of the fuel cell of First Comparative Example at the start of generation to the output density P0 of the fuel cell of First Example was 98%. Also, the temperature of the surface of the cathode gas diffusion layer 14 when the fuel cell of First Comparative Example generated electricity was measured, with the result that the temperature of the center in the direction of plane of the cathode gas diffusion layer was 55° C. and the temperature of the periphery in the direction of plane of the cathode gas diffusion layer was 51° C.

### Second Comparative Example

A fuel cell according to Second Comparative Example in the present invention will be explained with reference to the drawings. In the fuel cell according to this Comparative Example, a polyethylene porous film having a uniform thickness of 0.75 mm, a uniform porosity of 26%, an air permeability of 1.7 sec/100 cm³ (according to the measuring method prescribed in JIS P-8117) and a water-vapor permeability of 3000 g/(m²·24 h) (according to the measuring method prescribed in JIS L-1099 A-1) was cut into a rectangular form 84 mm in length and 47 mm in width, to use the resulting film as the humidification layer 20. Also, as the surface cover 23, a stainless plate having a uniform thickness of 1.0 mm was used. A fuel cell was thus formed in the same manner as in First Example except for the above structures.

The ratio (P1/P0) of the output density P1 to output density P0 of the fuel cell of this Second Comparative Example was calculated in the same manner as in the case of the fuel cell according to First Example, to find that it was 0.88 (88%).

The ratio of the output density P0 of the fuel cell of Second Comparative Example at the start of generation to the output density P0 of the fuel cell of First Example was 94%. Also, the temperature of the surface of the cathode gas diffusion layer 14 when the fuel cell of Second Comparative Example generated electricity was measured, with the result that the temperature of the center in the direction of plane of the cathode gas diffusion layer was 54° C. and the temperature of the periphery in the direction of plane of the cathode gas diffusion layer was 50° C.

An example of the results of evaluation for each fuel cell obtained in First to Third Examples and First and Second Comparative Examples is shown in FIG. 4. As shown in FIG. 4, all of the fuel cell according to First Example in which the humidification layer 20 is made to be thicker in the center than in the periphery in its plane direction, the fuel cell according to Second Example in which the humidification layer 20 is made to have a lower porosity in the center than in the periphery in its plane direction, and the fuel cell according to Third Example in which holes are formed in the peripheral part of the humidification layer are more improved than each fuel cell according to First and Second Comparative Examples in both the output density at the start of generation and the output density after generating electricity for 1000 hours.

On the contrary, First Comparative Example in which the humidification layer 20 is made to have a uniform thickness of 1.0 mm and a uniform porosity of 26% is largely inferior to First to Third Examples in output density after generating electricity for 1000 hours though it is hardly different from First to Third Examples in output density at the start of generation.

This is considered to be because, the thickness and porosity of the humidification layer 20 and the presence/absence of the holes formed in the periphery of the humidification layer 20 in the direction of plane are designed to be the same as those in the center of the humidification layer 20 in the direction of plane though the temperature of the cathode of the membrane electrode assembly 10 in the periphery of the humidification layer 20 in the direction of plane is low, and thus the amount of water retained in the cathode catalyst layer becomes more than necessary, which causes the flooding phenomenon in which pores of, for example, the cathode catalyst layer are clogged with water if generating time is prolonged, leading to a reduction in output.

The fuel cell of Second Comparative Example in which the humidification layer 20 is made to have a uniform thickness of 0.75 mm and a uniform porosity of 26% is largely inferior to each fuel cell obtained in First and Second Examples in output density at the start of generation.

This is considered to be because, the thickness and porosity of the humidification layer 20 in the center of the humidification layer 20 in the direction of plane are designed to be the same as those in the periphery of the humidification layer 20 in the direction of plane though the temperature of the cathode of the membrane electrode assembly 10 in the center of the humidification layer 20 in the direction of plane is high, and thus the amount of water supplied to the anode from the cathode is insufficient, so that the oxidation reaction of the liquid fuel in the anode catalyst layer is not smoothly run.

From the above results, the fuel cells shown in the above examples ensure that the amount of water retained in the cathode and water supplied to the anode from the cathode can be maintained in each appropriate range in all parts in the direction of plane of the humidification layer 20.

### Examples

Fuel cells according to examples of the present invention will be further explained with reference to the drawings. It is to be noted that in the following explanations, the same structures as those of the aforementioned fuel cell are designated by the same symbols and the explanation thereof is omitted.

### Fourth Example

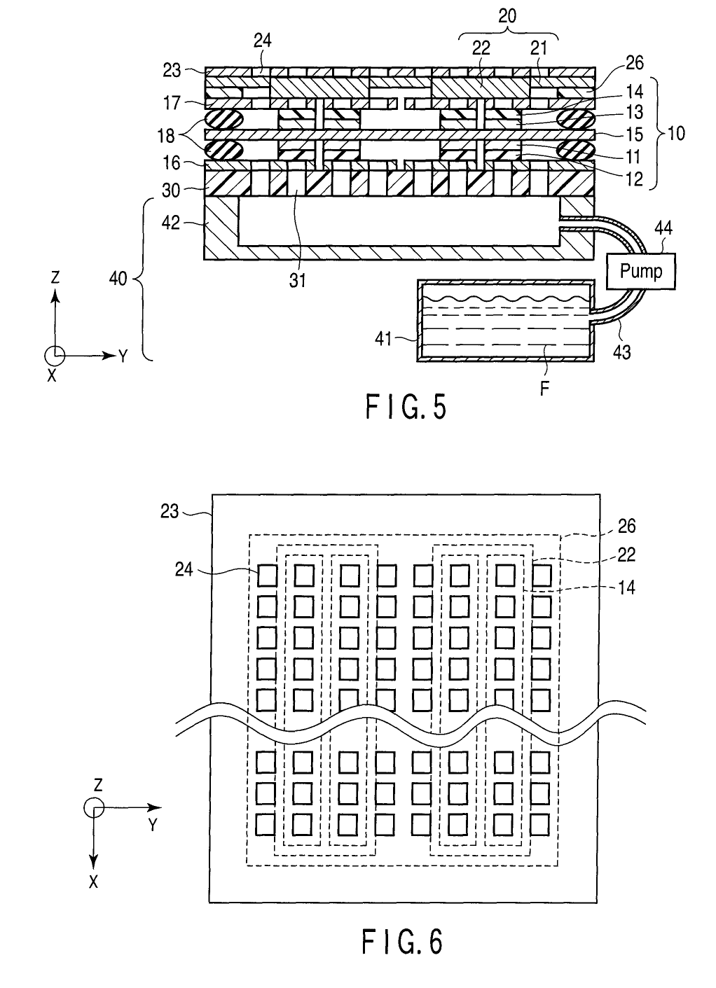

Another example of the fuel cell according to the first embodiment will be explained with reference to the drawings. In the fuel cell according to this example, porous carbon paper to be used for the anode gas diffusion layer 12 and cathode gas diffusion layer 14 is cut into a rectangular form having dimensions of 80×5 mm to fabricate a membrane electrode assembly 10 in such an arrangement as shown in FIGS. 5 and 6.

In the fuel cell according to this embodiment, as shown in FIGS. 5 and 6, four anode gas diffusion layers 12 and four cathode gas diffusion layers 14 are arranged such that their longitudinal sides are almost parallel to each other.

As the humidification layer 20, a polyethylene porous film having a thickness of 0.75 mm, a porosity of 26%, an air permeability of 1.7 sec/100 cm³ and a water-vapor permeability of 3000 g/(m²·24 h) was cut into a rectangular form 84 mm in length and 47 mm in width, and a rectangular hole 82 mm in length and 13 mm in width was opened at two positions in the rectangular film as the second humidification layer 21.

Next, a polyethylene porous film having the same properties as the second humidification layer 21 except for a thickness of 1.0 mm, an air permeability of 2.0 sec/100 cm³ and a water-vapor permeability of 2000 g/(m²·24 h) was cut into a rectangular form 82 mm in length and 13 mm in width as the first humidification layer 22.

This first humidification layer 22 was fitted into each of the two rectangular holes formed in the second humidification layer 21 such that these layers had the same plane on the sides which were in contact with the cathode conductive layer 17 to thereby manufacture a humidification layer 20. As shown in FIG. 6, the first humidification layer 22 is disposed such that it is overlapped in the direction of Z on the area where the anode gas diffusion layer 12 and the cathode gas diffusion layer 14 are disposed. Also, a stainless plate (SUS304) having a uniform thickness of 1.0 mm was used as the surface cover 23.

Also, as shown in FIG. 3, the first humidification layer 22 and the second humidification layer 21 are so designed as to be brought into contact with the surface cover 23 on the same plane with a spacer 26 interposed between the second humidification layer and the cathode conductive layer 17, the spacer being made of PTFE (trade name: Teflon (registered trademark), a polytetrafluoroethylene) having a thickness of 0.25 mm and the same outside form and size as the O-ring 18. The fuel cell according to this embodiment has the same structure as the fuel cell of First Example except for the above structures.

Pure methanol having a purity of 99.9% by weight was supplied to the fuel cell manufactured in the above manner in an environment of a temperature of 25° C. and a relative humidity of 50%. Also, a constant voltage power source was connected to the fuel cell to control current flow through the fuel cell such that the voltage output of the fuel cell was fixed to 0.3 V per one pair of four pairs of unit cells connected in series.

The output density P1 of the fuel cell after the generating operation was carried out for 1000 hours and the output density P0 of the fuel cell when the generating operation started were measured under the above condition. Then, the ratio (P1/P0) of the output density P1 to the output density P0 was calculated, to find that it was 0.90 (90%). Also, the ratio of the output density P0 of the fuel cell of Fourth Example at the start of generation to the output density P0 of the fuel cell of Third Example was 100%.

### Fifth Example

Next, other example of the fuel cell according to the first embodiment will be explained with reference to the drawings. In the fuel cell according to this embodiment, a polyethylene porous film having a thickness of 0.5 mm, a porosity of 26%, an air permeability of 1.5 sec/100 cm³ and a water-vapor permeability of 4000 g/(m²·24 h) was used as the second humidification layer 21 and the spacer 26 was made to have a thickness of 0.5 mm. The fuel cell according to this example has the same structure as the fuel cell of Fourth Example except for the above structures.

The ratio (P1/P0) of the output density P1 to output density P0 of this fuel cell of Fifth Example was calculated in the same manner as in the case of the fuel cell according to the above Fourth Example, to find that it was 0.94 (94%). The ratio of the output density P0 of the fuel cell of Fifth Example at the start of generation to the output density P0 of the fuel cell of Third Example was 99%.

### Sixth Example

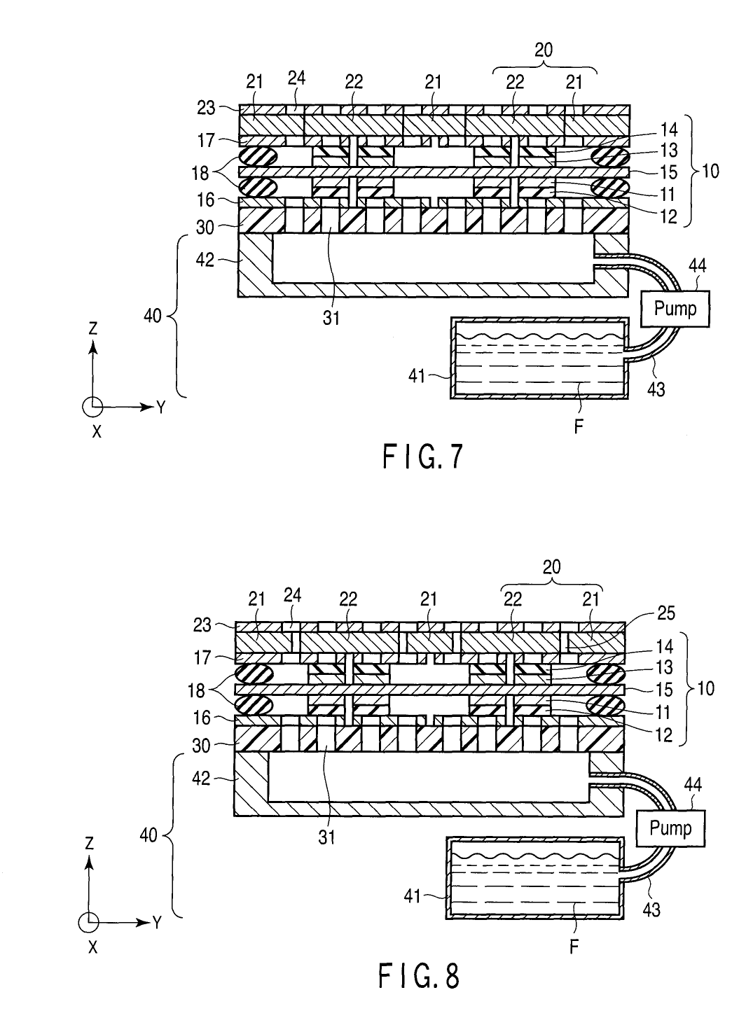

Next, other example of the fuel cell according to the second embodiment will be explained. In the fuel cell according to this embodiment, as shown in FIG. 7, a polyethylene porous film having a thickness of 1.0 mm, a porosity of 35%, an air permeability of 1.7 sec/100 cm³ and a water-vapor permeability of 3000 g/(m²·24 h) was used as the second humidification layer 21 and the spacer 26 was not used. The fuel cell according to this example has the same structure as the fuel cell of Fourth Example except for the above structures.

The ratio (P1/P0) of the output density P1 to output density P0 of this fuel cell of Sixth Example was calculated in the same manner as in the case of the fuel cell according to the above Fourth Example, to find that it was 0.90 (90%). The ratio of the output density P0 of the fuel cell of Sixth Example at the start of generation to the output density P0 of the fuel cell of First Example was 100%.

### Seventh Example

Next, other example of the fuel cell according to the second embodiment will be explained. In the fuel cell according to this example, as shown in FIG. 7, a polyethylene porous film having a thickness of 1.0 mm, a porosity of 50%, an air permeability of 1.5 sec/100 cm³ and a water-vapor permeability of 4000 g/(m²·24 h) was used as the second humidification layer 21 and the spacer 26 was not used. The fuel cell according to this example has the same structure as the fuel cell of Fourth Example except for the above structures.

The ratio (P1/P0) of the output density P1 to output density P0 of this fuel cell of Seventh Example was calculated in the same manner as in the case of the fuel cell according to the above First Example, to find that it was 0.93 (93%). The ratio of the output density P0 of the fuel cell of Third Example at the start of generation to the output density P0 of the fuel cell of First Example was 99%.

### Eighth Example

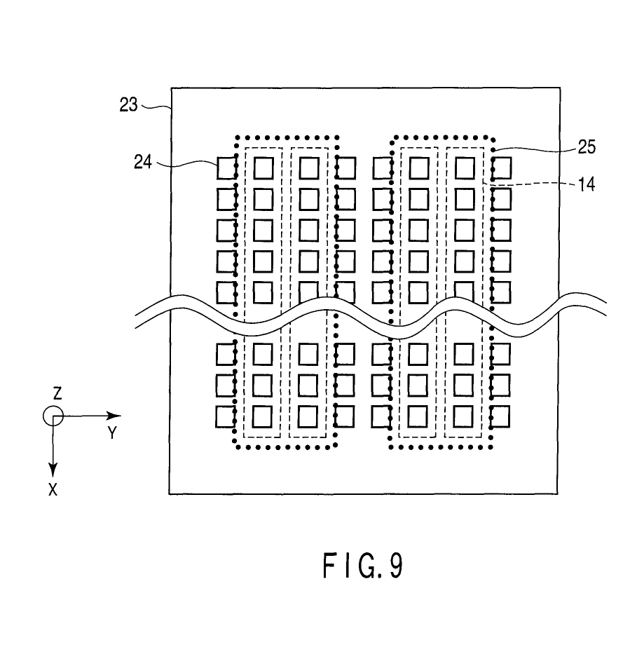

Next, other example of the fuel cell according to the third embodiment will be explained. In the fuel cell according to this example, as shown in FIGS. 8 and 9, a polyethylene porous film having a thickness of 1.0 mm, a porosity of 26%, an air permeability of 2.0 sec/100 cm³ and a water-vapor permeability of 2000 g/(m²·24 h) was used and though-holes 25 0.5 mm in diameter were formed at intervals of 2 mm along the periphery of a rectangle 82 mm in length and 13 mm in width at positions surrounding the outer periphery of pairs of two cathode gas diffusion layers 14 among four cathode gas diffusion layers 14 to form a humidification layer, which was used as the humidification layer 20.

Here, the humidification layer which is positioned just above the cathode gas diffusion layer 14 and in which no through-hole is formed serves as the first humidification layer 22 and the humidification layer which is positioned on the periphery of the cathode gas diffusion layer 14 and includes the pierced parts serves as the second humidification layer 21. In this case, the spacer 26 was not used. The fuel cell according to this example has the same structure as the fuel cell of Fourth Example except for the above structures.

The ratio (P1/P0) of the output density P1 to output density P0 of this fuel cell of Eighth Example was calculated in the same manner as in the case of the fuel cell according to the above Fourth Example, to find that it was 0.90 (90%). The ratio of the output density P0 of the fuel cell of Eighth Example at the start of generation to the output density P0 of the fuel cell of Third Example was 100%.

### Ninth Example

Next, other example of the fuel cell according to the third embodiment will be explained. The fuel cell according to this example has the same structure as the fuel cell of Eighth Example except that the diameter of the through-hole formed in the second humidification layer 21 was altered to 0.2 mm.

The ratio (P1/P0) of the output density P1 to output density P0 of this fuel cell of Ninth Example was calculated in the same manner as in the case of the fuel cell according to the above Fourth Example, to find that it was 0.88 (88%). The ratio of the output density P0 of the fuel cell of Ninth Example at the start of generation to the output density P0 of the fuel cell of Third Example was 98%.

### Tenth Example

Next, other example of the fuel cell according to the third embodiment will be explained. The fuel cell according to this example has the same structure as the fuel cell of Eighth Example except that the diameter of the through-hole formed in the second humidification layer 21 was altered to 1.5 mm.

The ratio (P1/P0) of the output density P1 to output density P0 of this fuel cell of Tenth Example was calculated in the same manner as in the case of the fuel cell according to the above Fourth Example, to find that it was 0.95 (95%). The ratio of the output density P0 of the fuel cell of Tenth Example at the start of generation to the output density P0 of the fuel cell of Third Example was 98%.

### Eleventh Example

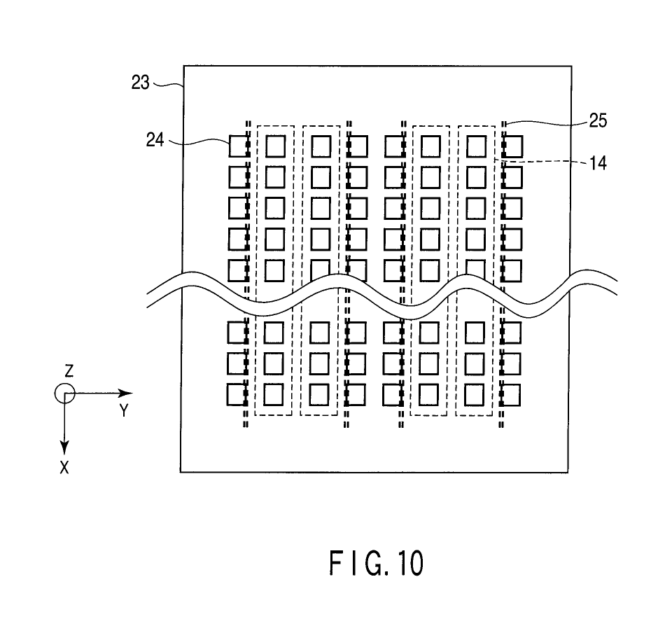

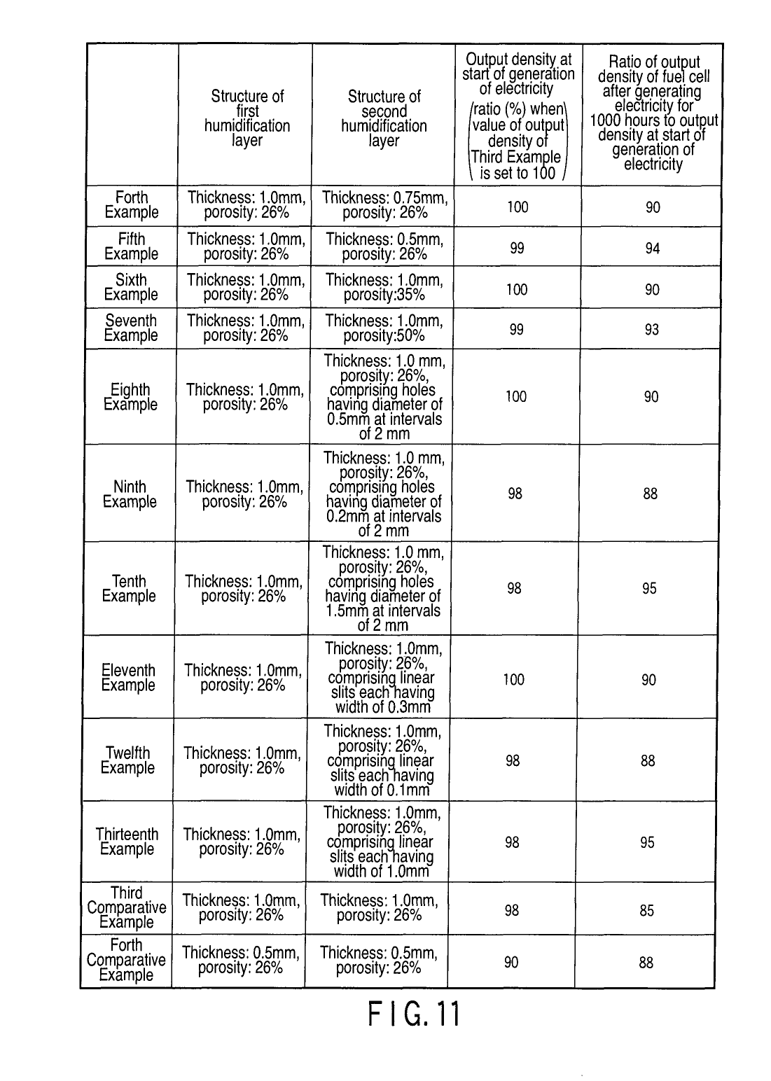

Next, other example of the fuel cell according to the third embodiment will be explained. In the fuel cell according to this example, a polyethylene porous film having a thickness of 1.0 mm, a porosity of 26%, an air permeability of 2.0 sec/100 cm³ and a water-vapor permeability of 2000 g/(m²·24 h) was used as the humidification layer 20. This humidification layer 20 comprises, as shown in FIG. 10, four 82-mm-long and 0.3-mm-wide slits 25 having an almost linear form so as to be disposed in parallel to the long sides of four cathode gas diffusion layers, respectively.

Here, the humidification layer which is disposed just above the cathode gas diffusion layer 14 and formed with no slit 25 serves as the first humidification layer 22 and the humidification layer which is disposed above an area positioned around the cathode gas diffusion layer 14 and includes parts having the slits 25 serves as the second humidification layer 21. In this case, the spacer 26 is not used. The fuel cell according to this example has the same structure as the fuel cell of Fourth Example except for the above structures.

The ratio (P1/P0) of the output density P1 to output density P0 of this fuel cell of Eleventh Example was calculated in the same manner as in the case of the fuel cell according to the above Fourth Example, to find that it was 0.90 (90%). The ratio of the output density P0 of the fuel cell of Eleventh Example at the start of generation to the output density P0 of the fuel cell of Third Example was 100%.

### Twelfth Example

Next, other example of the fuel cell according to the third embodiment will be explained. In the fuel cell according to this example, the width of the slit 25 formed in the second humidification layer 21 was altered to 0.1 mm. The fuel cell according to this example has the same structure as the fuel cell of Eleventh Example except for the above structures.

The ratio (P1/P0) of the output density P1 to output density P0 of this fuel cell of Twelfth Example was calculated in the same manner as in the case of the fuel cell according to the above Fourth Example, to find that it was 0.88 (88%). The ratio of the output density P0 of the fuel cell of Twelfth Example at the start of generation to the output density P0 of the fuel cell of Third Example was 98%.

### Thirteenth Example

Next, other example of the fuel cell according to the third embodiment will be explained. In the fuel cell according to this example, the width of the slit 25 formed in the second humidification layer 21 was altered to 1.0 mm. The fuel cell according to this example has the same structure as the fuel cell of Eleventh Example except for the above structures.

The ratio (P1/P0) of the output density P1 to output density P0 of this fuel cell of Thirteenth Example was calculated in the same manner as in the case of the fuel cell according to the above Fourth Example, to find that it was 0.95 (95%). The ratio of the output density P0 of the fuel cell of Thirteenth Example at the start of generation to the output density P0 of the fuel cell of Third Example was 98%.

### Comparative Examples

Fuel cells according to Comparative Examples of the present invention will be further explained.

### Third Comparative Example

A fuel cell according to Third Comparative Example of the present invention will be explained. In the fuel cell according to this Comparative Example, the first humidification layer 22 and the second humidification layer 21 in the humidification layer 20 were made to have exactly the same properties by using a polyethylene porous film having a thickness of 1.0 mm, a porosity of 26%, an air permeability of 2.0 sec/100 cm³ and a water-vapor permeability of 2000 g/(m²·24 h). In this case, the spacer 26 was not used. The fuel cell according to this example has the same structure as the fuel cell of Fourth Example except for the above structures.

The ratio (P1/P0) of the output density P1 to output density P0 of this fuel cell of Third Comparative Example was calculated in the same manner as in the case of the fuel cell according to the above Fourth Example, to find that it was 0.85 (85%). Also, the ratio of the output density P0 of the fuel cell of Third Comparative Example at the start of generation to the output density P0 of the fuel cell of Third Example was 98%.

### Fourth Comparative Example

A fuel cell according to Fourth Comparative Example of the present invention will be explained. In the fuel cell according to this Comparative Example, the first humidification layer and the second humidification layer in the humidification layer 20 were made to have exactly the same properties by using a polyethylene porous film having a thickness of 0.5 mm, a porosity of 26%, an air permeability of 1.5 sec/100 cm³ and a water-vapor permeability of 4000 g/(m²·24 h). In this case, the spacer 26 was not used. The fuel cell according to this Comparative Example has the same structure as the fuel cell of Fourth Example except for the above structures.

The ratio (P1/P0) of the output density P1 to output density P0 of this fuel cell of Fourth Comparative Example was calculated in the same manner as in the case of the above Fourth Example, to find that it was 0.88 (88%). Also, the ratio of the output density P0 of the fuel cell of Fourth Comparative Example at the start of generation to the output density P0 of the fuel cell of Third Example was 90%.

An example of the results of evaluation for each fuel cell obtained in the above Fourth to Thirteenth Examples and Third and Fourth Comparative Examples is shown in FIG. 11. As shown in FIG. 11, the fuel cells according to Fourth and Fifth Examples in which the first humidification layer 22 is made to be thicker than the second humidification layer 21, the fuel cells according to Sixth and Seventh Examples in which the first humidification layer 22 is made to have a lower porosity than the second humidification layer 21, the fuel cells according to Eighth to Tenth Examples in which the second humidification layer 21 comprises holes, and the fuel cells according to Eleventh to Thirteenth Examples in which the second humidification layer 21 comprises slits are all superior to the fuel cells of Third and Fourth Comparative Examples in the output density at the start of generation and output density after generating electricity for 1000 hours.

The results of evaluation shown in FIG. 11 show that each fuel cell obtained in Fourth to Thirteen Examples has a high output and can maintain the output stably for a long period of time. Specifically, the fuel cells shown in the Examples can keep the amount of water to be retained in the cathode and the amount of water to be supplied from the cathode to the anode in each appropriate range in all parts extending in the direction of plane of the humidification layer 20.

Accordingly, the fuel cells according to the first to third embodiments ensure that a fuel cell capable of maintaining stable output for a long period of time can be provided.

The invention is not limited to the above embodiments as it stands and may be embodied by modifying the structural elements in practical stages within the scope of the invention. For example, the first humidification section 22 and the second humidification section 21 shown in FIG. 1 may be respectively constituted of plural layers. Also, the humidification layer 20 may have a structure in which it comprises plural layers as shown in FIG. 2B and also, the thickness is continuously varied between the periphery and center in the direction of plane of the humidification layer 20 as shown in FIG. 2A. In this case, the same effect as that of the fuel cell according to the above embodiments is obtained.

Also, in each fuel cell according to Third and Eighth to Tenth Examples, the hole to be formed in the humidification layer 20 is one which penetrates the humidification layer 20 in the direction of thickness thereof and has a cylinder form. However, the shape of the hole is not limited to the cylinder form and may be, for example, a polygonal prism form. Also, in each fuel cell obtained in Eleventh to Thirteenth Examples, the slit formed in the humidification layer 20 has a linear form. However, the shape of the slit is not limited to the linear form but may be a curve form or dotted-line form.

Also, various inventions can be made by proper combinations of plural structural elements disclosed in the embodiments. For example, several structural elements may be deleted from all structural elements shown in the embodiments. Moreover, the structural elements in different embodiments may be appropriately combined.

For example, the fuel cell according to the first embodiment may be combined with the fuel cell according the second embodiment to constitute the humidification layer 10 comprising the first humidification section 22 and the second humidification section 21 which is thinner and has a higher porosity than the first humidification section 22.

Also, the fuel cell according to the first embodiment may be combined with the fuel cell according the third embodiment to constitute the humidification layer 20 comprising the first humidification section 22 and the second humidification section 21 which is thinner than the first humidification section 22 and comprises predetermined holes or slits.

Also, the fuel cell according to the second embodiment may be combined with the fuel cell according the third embodiment to constitute the humidification layer 20 comprising the first humidification section 22 and the second humidification section 21 which has a higher porosity than the first humidification section 22 and comprises predetermined holes or slits.

Also, the fuel cells according to the first to third embodiments may be combined to constitute the humidification layer 20 comprising the first humidification section 22 and the second humidification section 21 which is thinner and has a higher porosity than the first humidification section 22 and comprises predetermined holes or slits.

The present invention can provide a fuel cell which can maintain the output stably for a long period of time.

What is claimed is:

1. A fuel cell comprising:
a membrane electrode assembly comprising a fuel electrode, an air electrode and an electrolyte membrane interposed between the fuel electrode and the air electrode;
a fuel supply mechanism disposed on the air electrode side of the membrane electrode assembly to supply fuel to the fuel electrode; and
a humidification layer disposed on the air electrode side of the membrane electrode assembly to be impregnated with water produced in the air electrode,
wherein the humidification layer comprises a first humidification section disposed opposite to a high-temperature area of an air electrode and a second humidification section disposed opposite to a low-temperature area of the air electrode when generating electricity, and
the second humidification section is so configured that water vapor is released into air therefrom more easily than from the first humidification section in the membrane electrode assembly.

2. The fuel cell according to claim 1, wherein the first humidification section is disposed opposite to at least a part of a periphery of the air electrode.

3. The fuel cell according to claim 1, wherein the first humidification section is disposed opposite to a center of the air electrode in a direction of plane thereof, and the second humidification section is disposed opposite to the periphery of the air electrode in the direction of plane thereof so as to enclose the first humidification section.

4. The fuel cell according to claim 1, wherein the second humidification section has a frame form with a hole formed in the center thereof in the direction of plane and the first humidification section is disposed in the hole of the second humidification section.

5. The fuel cell according to claim 1, wherein the second humidification section is thinner than the first humidification section.

6. The fuel cell according to claim 1, wherein the humidification layer is constituted of a plurality of layers and the first humidification section comprises more layers than the second humidification section.

7. The fuel cell according to claim 1, wherein a thickness of the humidification layer is continuously increased from the second humidification section toward the first humidification section.

8. The fuel cell according to claim 1, wherein the first humidification section has a lower porosity than the second humidification section.

9. The fuel cell according to claim 8, wherein the porosity of the humidification layer is continuously decreased from the second humidification section toward the first humidification section.

10. The fuel cell according to claim 1, wherein the second humidification section comprises at least one of a hole having a diameter 0.1 or more times a thickness of the second humidification section and a slit having a width 0.1 or more times the thickness of the second humidification section.

11. The fuel cell according to claim 2, wherein the first humidification section is disposed opposite to a center of the air electrode in a direction of plane thereof, and the second humidification section is disposed opposite to the periphery of the air electrode in the direction of plane thereof so as to enclose the first humidification section.

12. The fuel cell according to claim 2, wherein the second humidification section has a frame form with a hole formed in the center thereof in the direction of plane and the first humidification section is disposed in the hole of the second humidification section.

13. The fuel cell according to claim 2, wherein the second humidification section is thinner than the first humidification section.

14. The fuel cell according to claim 2, wherein the humidification layer is constituted of a plurality of layers and the first humidification section comprises more layers than the second humidification section.

15. The fuel cell according to claim 2, wherein a thickness of the humidification layer is continuously increased from the second humidification section toward the first humidification section.

16. The fuel cell according to claim 2, wherein the first humidification section has a lower porosity than the second humidification section.

17. The fuel cell according to claim 2, wherein the second humidification section comprises at least one of a hole having a diameter 0.1 or more times a thickness of the second humidification section and a slit having a width 0.1 or more times the thickness of the second humidification section.
